(19) United States
(12) Patent Application Publication
(10) Pub. No.: US 2019/0186495 A1
(43) Pub. Date: Jun. 20, 2019

(54) BLOWER

(71) Applicant: NIDEC SERVO CORPORATION, Kiryu-shi, Gunma (JP)

(72) Inventors: Takahiro BAMBA, Kiryu-shi (JP); Taro TANNO, Kiryu-shi (JP); Yoshihiko KATO, Kiryu-shi (JP)

(73) Assignee: NIDEC SERVO CORPORATION, Kiryu-shi, Gunma (JP)

(21) Appl. No.: 16/311,233

(22) PCT Filed: Jun. 23, 2017
(86) PCT No.: PCT/JP2017/023247

§ 371 Date: Dec. 19, 2018

Related U.S. Application Data
(60) Provisional application No. 62/354,190, filed on Jun. 24, 2016.

(51) Int. Cl. F04D 25/06; H02K 21/22; F04D 29/32; F04D 29/52

(52) U.S. Cl. CPC F04D 25/06; H02K 21/22; F04D 25/08; F04D 29/522; F04D 29/325

(57) ABSTRACT

A blower includes a motor and an impeller. The motor includes a rotor cup that includes a first cylindrical portion that has a cylindrical shape and that holds the rotor magnet. The impeller includes an impeller cup including a cylindrical second cylindrical portion that surrounds the first cylindrical portion on an outer side of the rotor cup in the radial direction, and blade portions on a radial-direction outer surface of the second cylindrical portion. The rotor cup includes a flange portion that protrudes outward in the radial direction from a lower portion of the first cylindrical portion. Of the flange portion and the impeller cup, one includes a first hole portion recessed in an axial direction, and the other includes a first protruding portion at least partially located inside the first hole portion.

### BACKGROUND OF THE INVENTION

### 1. Field of the Invention

The present disclosure relates to a blower.

### 2. Description of the Related Art

A blower in which an impeller is mounted on a rotor cup that holds a rotor magnet is known. For example, as a conventional blower, a blower that includes a motor yoke, serving as a rotor cup, and an impeller is known.

In blowers, such as the conventional blower, when the rotor cup and the impeller are rotated at a high speed, an impeller cup of the impeller mounted on the rotor cup may become deformed in a radial direction by, for example, a centrifugal force. Therefore, the flow of air around the impeller cup changes and air quantity characteristics of the blower may deteriorate. In addition, a blade portion of the impeller may become damaged due to the blade portion coming into contact with a housing that surrounds the impeller.

### SUMMARY OF THE INVENTION

A blower of an exemplary embodiment of the present disclosure includes a motor that includes a shaft that is disposed along a central axis extending in an up-down direction, and an impeller that is rotated around the central axis by the motor, wherein the motor includes a stator that surrounds the shaft on an outer side of the shaft in a radial direction, a rotor magnet that faces the stator in the radial direction with a gap interposed therebetween on an outer side of the stator in the radial direction, and a rotor cup that includes a first cylindrical portion that has a cylindrical shape and that holds the rotor magnet, the impeller includes an impeller cup including a cylindrical second cylindrical portion that surrounds the first cylindrical portion on an outer side of the rotor cup in the radial direction, and a plurality of blade portions that are located on a radial-direction outer surface of the second cylindrical portion, the rotor cup includes a flange portion that protrudes outward in the radial direction from a lower portion of the first cylindrical portion, one of the flange portion and the impeller cup includes a first hole portion that is recessed in an axial direction and the other of the flange portion and the impeller cup includes a first protruding portion, and at least a portion of the first protruding portion is located inside the first hole portion.

### BRIEF DESCRIPTION OF THE DRAWINGS

FIG. 1 is a sectional view showing a blower of a first exemplary embodiment of the present disclosure.

FIG. 2 is a perspective view showing an impeller and a rotor cup of the first exemplary embodiment of the present disclosure.

FIG. 3 is a top view of the rotor cup of the first exemplary embodiment of the present disclosure.

FIG. 4 is a sectional view showing a portion of the impeller and a portion of the rotor cup of the first exemplary embodiment of the present disclosure.

FIG. 5 is a perspective view showing a portion of the impeller and a portion of the rotor cup of the first exemplary embodiment of the present disclosure.

FIG. 6 is a perspective view showing a portion of the impeller of the first exemplary embodiment of the present disclosure.

FIG. 7 is a perspective view showing an impeller and a rotor cup of a second exemplary embodiment of the present disclosure.

FIG. 8 is a perspective view showing the rotor cup of the second exemplary embodiment of the present disclosure.

FIG. 9 is a top view of the rotor cup of the second exemplary embodiment of the present disclosure.

FIG. 10 is a sectional view showing a portion of the impeller and a portion of the rotor cup of the second exemplary embodiment of the present disclosure.

FIG. 11 is a perspective view showing the impeller of the second exemplary embodiment of the present disclosure.

### DETAILED DESCRIPTION OF THE PREFERRED EMBODIMENTS

A Z-axis direction that is shown as appropriate in each figure is an up-down direction in which a positive side is an upper side and a negative side is a lower side. Note that the up-down direction, the upper side, and the lower side are names for merely describing the relationships between relative positions of each portion. The actual arrangement relationships or the like may be, for example, arrangement relationships other than, for example, the arrangement relationships indicated by these names.

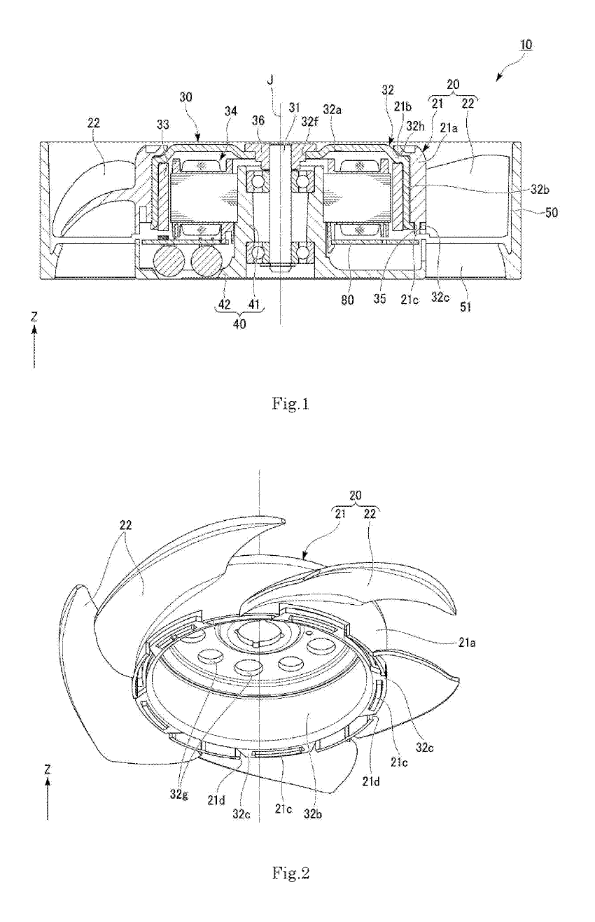

As shown in FIG. 1, a blower 10 of the embodiment includes a motor supporting section 40, a motor 30 including a shaft 31 that is disposed along a central axis J extending in the up-down direction, an impeller 20, a circuit board 80, and a housing 50. In the description below, a direction parallel to the central axis J, that is, the up-down direction is simply called “axial direction Z”. A radial direction around the central axis J is simply called “radial direction”, and a peripheral direction around the central axis J is simply called “peripheral direction”.

The motor supporting section 40 supports the motor 30. The motor supporting section 40 includes a bottom plate portion 42 and a stator supporting portion 41. The bottom plate portion 42 has the shape of a ring plate having the central axis J as the center. The stator supporting portion 41 has a cylindrical shape extending upward from an inner edge portion of the bottom plate portion 42 in the radial direction. The stator supporting portion 41 opens on both sides in the axial direction Z. Two bearings disposed apart from each other in the axial direction Z with a gap interposed therebetween are fixed to an inner surface of the stator supporting portion 41 in the radial direction.

The motor 30 includes the shaft 31, a stator 34, a rotor cup 32, and a rotor magnet 33. The shaft 31 is rotatably supported by the two bearings that are fixed to the inner surface of the stator supporting portion 41 in the radial direction. An upper end portion of the shaft 31 protrudes to a location above the stator supporting portion 41. A cylindrical mounting member 36 is fitted and fixed to the upper end portion of the shaft 31.

On an outer side of the shaft 31 in the radial direction, the stator 34 surrounds the shaft 31. The stator 34 has, for example, a ring shape having the central axis J as the center. The stator 34 is fixed to an outer surface of the stator supporting portion 41 in the radial direction.

The rotor cup 32 has a cylindrical shape that opens on the lower side. The rotor cup 32 is made of, for example, a metal. The rotor cup 32 includes a first cylindrical portion 32b, a cover portion 32a, and flange portions 32c. The first cylindrical portion 32b has a cylindrical shape extending in the axial direction Z and having the central axis J as the center. On an outer side of the stator 34 in the radial direction, the first cylindrical portion 32b surrounds the stator 34.

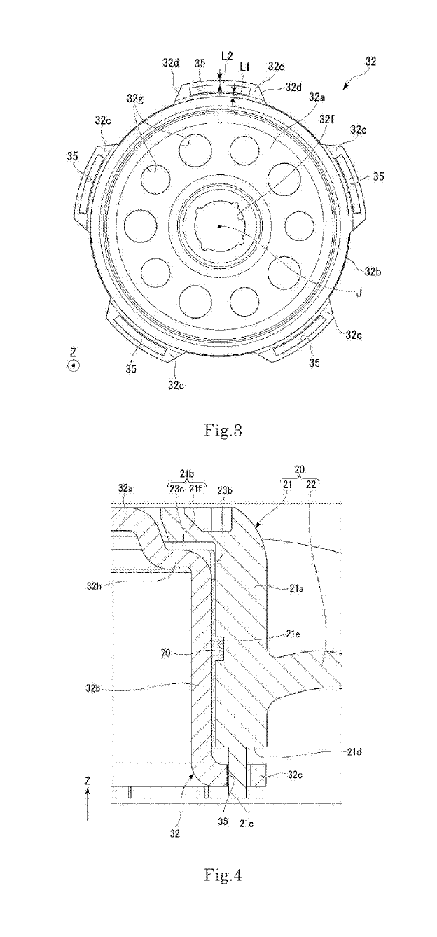

The cover portion 32a has the shape of a ring plate having the central axis J as the center. An outer edge portion of the cover portion 32a in the radial direction is connected to an upper end portion of the first cylindrical portion 32b. That is, the cover portion 32a is located on the upper end portion of the first cylindrical portion 32b. The cover portion 32a covers the upper side of the stator 34. An inner edge portion 32f of the cover portion 32a in the radial direction is fixed to the upper end portion of the shaft 31 with the mounting member 36 interposed therebetween. Accordingly, the rotor cup 32 is fixed to the shaft 31. The outer edge portion of the cover portion 32a in the radial direction is an impeller supporting portion 32h that is recessed downward. As shown in FIGS. 2 and 3, the cover portion 32a has a plurality of through holes 32g that extend through the cover portion 32a in the axial direction Z.

Each flange portion 32c protrudes outward in the radial direction from a lower portion of the first cylindrical portion 32b. More specifically, each flange portion 32c protrudes outward in the radial direction from a lower end portion of the first cylindrical portion 32b. In the embodiment, the rotor cup 32 includes the plurality of flange portions 32c. In FIGS. 2 and 3, the number of flange portions 32c is, for example, 5. The plurality of flange portions 32c are disposed at equal intervals around a circumference in the peripheral direction.

As shown in FIG. 3, the shape of each flange portion 32c as viewed from the upper side of each flange portion 32c is a substantially trapezoidal shape having a dimension in the peripheral direction that decreases from its inner side in the radial direction towards its outer side in the radial direction. Two edge portions 32d on respective peripheral-direction sides of each flange portion 32c are each inclined in a direction so as to approach the edge portion 32d on the opposite side from the inner side in the radial direction towards the outer side in the radial direction. Therefore, for example, when a part of a ring plate portion that protrudes outward in the radial direction from the first cylindrical portion 32b is punched out by using a press die to manufacture the flange portions 32c, the angle of a region along an outer surface of the first cylindrical portion 32b in the radial direction and each edge portion 32d at the punched-out portion is an obtuse angle. This allows the angle of the press die used to punch out a part of the ring plate portion to be an obtuse angle. Therefore, it is possible to suppress wear of the press die and to increase the life of the press die.

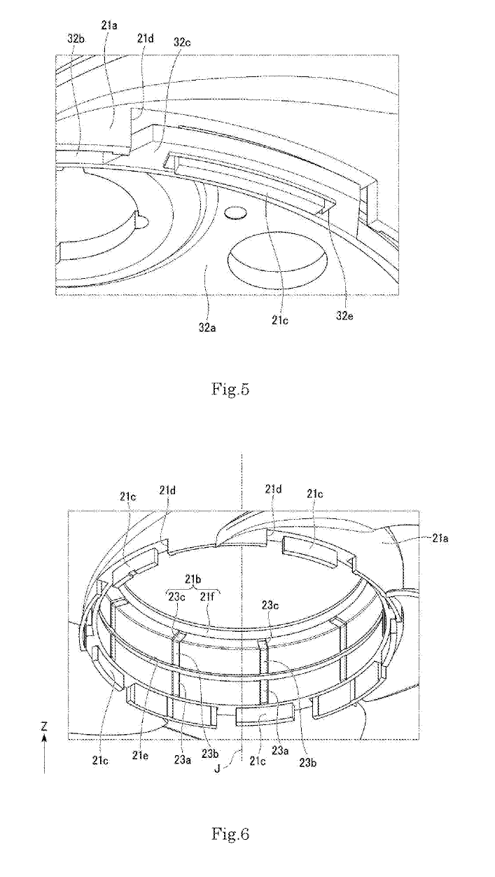

As shown in FIG. 4, in the radial direction, an outer end portion of a flange portion 32c in the radial direction is located substantially in correspondence with the position of a radial-direction outer surface of a second cylindrical portion 21a (described later) of an impeller cup 21. In the radial direction, the outer end portion of the flange portion 32c in the radial direction is located slightly inward of the radial-direction outer surface of the second cylindrical portion 21a. Therefore, compared to when the flange portion protrudes outward of the second cylindrical portion in the radial direction, the flow of air that flows along the radial-direction outer surface of the second cylindrical portion 21a is less likely to be hindered. Consequently, it is possible to suppress a reduction in the air quantity of the blower 10 and to reduce noise that is produced from the blower 10.

Each flange portion 32c includes a first hole portion 35 that is recessed in the axial direction Z. In the embodiment, each first hole portion 35 extends through its corresponding flange portion 32c in the axial direction Z. As shown in FIG. 3, each first hole portion 35 extends in the peripheral direction. Each first hole portion 35 is located in the center of its corresponding flange portion 32c in the radial direction. Therefore, a radial-direction dimension L1 of a radial-direction inner portion of the first hole portion 35 of each flange portion 32c is substantially the same as a radial-direction dimension L2 of a radial-direction outer portion of the first hole portion 35 of each flange portion 32c. This makes it easier to ensure the strength of each flange portion 32c. In addition, when forming each first hole portion 35 by punching out a part of its corresponding flange portion 32c, each first hole portion 35 is easier to form.

In the embodiment, each first hole portion 35 is formed, for example, by punching out a part of its corresponding flange portion 32c by using a press die. More specifically, with a lower surface of each flange portion 32c being set in the die, a punch is brought close to each flange portion 32c from the upper side of each flange portion 32c to punch out a part of each flange portion 32c. Therefore, as shown in FIG. 5, for example, a burr 32e is formed in a peripheral edge portion of a first hole portion 35 at the lower surface of its corresponding flange portion 32c. That is, the rotor cup 32 includes the burrs 32e that are each located on the peripheral edge portion of its corresponding first hole portion 35 at the lower surface of its corresponding flange portion 32c.

As shown in FIG. 1, the rotor magnet 33 is fixed to an inner surface of the first cylindrical portion 32b in the radial direction. Therefore, the first cylindrical portion 32b holds the rotor magnet 33. On the outer side of the stator 34 in the radial direction, the rotor magnet 33 faces the stator 34 in the radial direction with a gap interposed therebetween.

The impeller 20 is rotated around the central axis J by the motor 30. The impeller 20 is made of, for example, a resin. The impeller 20 includes a plurality of blade portions 22 and the impeller cup 21. As shown in FIG. 2, the plurality of blade portions 22 are located on the radial-direction outer surface of the second cylindrical portion 21a (described below) of the impeller cup 21. The plurality of blade portions 22 are disposed at equal intervals around a circumference in the peripheral direction. In FIG. 2, the number of blade portions 22 is, for example, 5. By rotating the impeller 20, the blade portions 22 blow air in the axial direction Z.

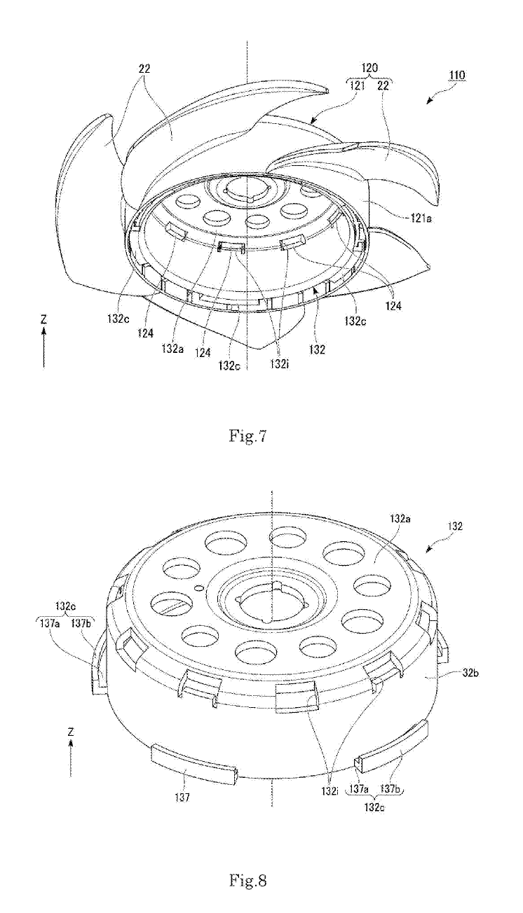

As shown in FIG. 1, the impeller cup 21 has a cylindrical shape that opens on both sides in the axial direction Z. The impeller cup 21 is fitted to the rotor cup 32 from an outer side in the radial direction. As shown in FIG. 6, the impeller cup 21 includes the second cylindrical portion 21a, a plurality of first ribs 23a and a plurality of second ribs 23b, which correspond to a plurality of ribs, a contact portion 21b, and first protruding portions 21c.

As shown in FIG. 1, the second cylindrical portion 21a has a cylindrical shape that surrounds the first cylindrical portion 32b on an outer side of the rotor cup 32 in the radial direction. More specifically, the second cylindrical portion 21a has a cylindrical shape having the central axis J as the center. As shown in FIG. 6, the second cylindrical portion 21a includes a first recessed portion 21e that is recessed outward in the radial direction from an inner surface of the second cylindrical portion 21a in the radial direction. In FIG. 6, the first recessed portion 21e is a groove that extends in the shape of a ring in the peripheral direction. The first recessed portion 21e is located in an axial-direction-Z center of the inner surface of the second cylindrical portion 21a in the radial direction. The second cylindrical portion 21a includes a plurality of second recessed portions 21d that are recessed upward from a lower end portion of the second cylindrical portion 21a. The plurality of second recessed portions 21d are disposed at equal intervals around a circumference in the peripheral direction.

The plurality of first ribs 23a and the plurality of second ribs 23b protrude inward in the radial direction from the inner surface of the second cylindrical portion 21a in the radial direction. The first ribs 23a are located at portions of the radial-direction inner surface of the second cylindrical portion 21a that are on the lower side of the first recessed portion 21e. The first ribs 23a extend in the axial direction Z from a lower end portion of the radial-direction inner surface of the second cylindrical portion 21a to a lower edge portion of the first recessed portion 21e. The plurality of first ribs 23a are disposed apart from each other in the peripheral direction with gaps interposed therebetween. More specifically, the plurality of first ribs 23a are disposed at equal intervals around a circumference in the peripheral direction.

The second ribs 23b are located at portions of the radial-direction inner surface of the second cylindrical portion 21a that are on the upper side of the first recessed portion 21e. The second ribs 23b extend in the axial direction Z from an upper end portion of the radial-direction inner surface of the second cylindrical portion 21a to an upper edge portion of the first recessed portion 21e. The plurality of second ribs 23b are disposed apart from each other in the peripheral direction with gaps interposed therebetween. The plurality of second ribs 23b are disposed at equal intervals around a circumference in the peripheral direction. The plurality of first ribs 23a and the plurality of second ribs 23b are situated at corresponding positions in the peripheral direction.

The plurality of first ribs 23a and the plurality of second ribs 23b are in contact with an outer surface of the first cylindrical portion 32b in the radial direction. That is, the impeller cup 21 is in contact with an outer surface of the rotor cup 32 in the radial direction with the plurality of first ribs 23a and the plurality of second ribs 23b interposed therebetween. This allows the contact area between the impeller cup 21 and the outer surface of the rotor cup 32 in the radial direction to be reduced. Therefore, when, for example, the thermal expansion coefficient of the impeller cup 21 and the thermal expansion coefficient of the rotor cup 32 differ from each other, it is possible to reduce a stress that is produced between the rotor cup and the impeller cup 21 by thermal expansion or thermal contraction. Consequently, it is possible to suppress damage to the impeller cup 21 and the rotor cup 32.

Specifically, when the impeller 20 is made of a resin and the rotor cup 32 is made of a metal, for example, the thermal expansion coefficient of the impeller 20 is larger than the thermal expansion coefficient of the rotor cup 32. In this case, for example, when the blower 10 is placed under a low-temperature environment, the deformation amount resulting from the thermal contraction of the impeller cup 21 is larger than the deformation amount resulting from the thermal contraction of the rotor cup 32. Even in this case, since it is possible to reduce a stress that is produced in the impeller cup 21 as mentioned above, it is possible to suppress damage to the impeller cup 21 made of a resin.

As shown in FIG. 4, the contact portion 21b protrudes towards the inner side in the radial direction from an upper portion of the second cylindrical portion 21a. More specifically, the contact portion 21b protrudes inward in the radial direction from an upper end portion of the second cylindrical portion 21a. As shown in FIG. 6, the contact portion 21b includes a ring-shaped portion 21f and a plurality of third ribs 23c. The ring-shaped portion 21f has a ring shape having the central axis J as the center. An outer edge portion of the ring-shaped portion 21f in the radial direction is connected to the upper end portion of the second cylindrical portion 21a. As shown in FIG. 4, the ring-shaped portion 21f is located on the upper side of the impeller supporting portion 32h. A radial-direction inner end portion of the ring-shaped portion 21f faces the cover portion 32a in the radial direction with a gap interposed therebetween.

As shown in FIG. 6, each third rib 23c protrudes downward from a lower surface of the ring-shaped portion 21f. Each third rib 23c extends in the radial direction. The plurality of third ribs 23c are disposed at equal intervals around a circumference in the peripheral direction. The plurality of third ribs 23c and the plurality of second ribs 23b are disposed at corresponding positions in the peripheral direction. An outer end portion of each third rib 23c in the radial direction is connected to the upper end portion of its corresponding second rib 23b.

As shown in FIG. 4, the contact portion 21b is in contact with the rotor cup 32 on the upper side of the rotor cup 32. More specifically, each third rib 23c is in contact with an upper surface of the impeller supporting portion 32h. That is, the impeller cup 21 is in contact with an upper surface of the rotor cup 32 with the plurality of third ribs 23c interposed therebetween. This allows the contact area between the impeller cup 21 and the upper surface of the rotor cup 32 to be reduced. Therefore, for example, when the thermal expansion coefficient of the impeller cup 21 and the thermal expansion coefficient of the rotor cup 32 differ from each other, it is possible to reduce a stress that is produced between the impeller cup 21 and the rotor cup 32 by thermal expansion or thermal contraction. Consequently, it is possible to suppress damage to the impeller cup 21 and the rotor cup 32.

In a state in which the contact portion 21b is in contact with the rotor cup 32, the second cylindrical portion 21a is disposed apart from and above each flange portion 32c. That is, each flange portion 32c is disposed apart from the lower side of the second cylindrical portion 21a with a gap interposed therebetween. Therefore, by bringing the contact portion 21b into contact with the impeller supporting portion 32h, it is possible to precisely position the impeller cup 21 with respect to the rotor cup 32 in the axial direction Z.

Each first protruding portion 21c protrudes downward from the second cylindrical portion 21a. More specifically, as shown in FIG. 6, each first protruding portion 21c protrudes downward from a downwardly facing face of an inner surface of its corresponding second recessed portion 21d. A lower end portion of each first protruding portion 21c is located, for example, in correspondence with the position of the lower end portion of the second cylindrical portion 21a in the axial direction Z. Each first protruding portion 21c extends in the peripheral direction. Each first protruding portion 21c has the shape of a rectangular plate that is curved in the shape of an arc in the peripheral direction.

As shown in FIG. 4, at least a part of each first protruding portion 21c is located inside its corresponding first hole portion 35. Therefore, for example, even if a centrifugal force or the like is applied to the impeller cup 21 and the impeller cup 21 tries to deform outward in the radial direction, each first protruding portion 21c is caught by an inner surface of its corresponding first hole portion 35, such that it is possible to suppress deformation of the impeller cup 21. This makes it possible to suppress a reduction in the air quantity characteristics of the blower 10. In addition, it is possible to inhibit the blade portions 22 from contacting the housing 50 and to suppress damage to the blade portions 22. Further, it is possible to suppress rotation of the impeller cup 21 with respect to the rotor cup 32 in the peripheral direction.

For example, in FIG. 4, in the radial direction, each first protruding portion 21c is located apart from both radial-direction faces of the inner surface of its corresponding first hole portion 35. When the impeller cup 21 is deformed outward in the radial direction from this state, each first protruding portion 21c comes into contact with and is caught by the radial-direction outer face of the inner surface of its corresponding first hole portion 35. This makes it possible to inhibit movement of each first protruding portion 21c outward in the radial direction beyond its corresponding first hole portion 35 and to suppress deformation of the impeller cup 21.

In the embodiment, each flange portion 32c includes its corresponding first hole portion 35 and the impeller cup 21 includes its corresponding first protruding portion 21c. Therefore, compared to when each first hole portion is formed in the impeller cup 21, it is possible easily form each first hole portion 35 by punching out a part of each flange portion 32c.

Each first protruding portion 21c is inserted into its corresponding first hole portion 35 from thereabove. Each first protruding portion 21c extends through its corresponding first hole portion 35 in the axial direction Z. The lower end portion of each first protruding portion 21c is located below its corresponding flange portion 32c. Therefore, each first protruding portion 21c is reliably and easily caught by its corresponding first hole portion 35 and deformation of the impeller cup 21 can be further suppressed. In addition, for example, a weight for adjusting the center-of-gravity balance may be mounted on the lower end portion of each first protruding portion 21c.

In the embodiment, the burrs 32e that are formed when the first hole portions 35 are punched out by using a press die are located on the lower surfaces of the respective flange portions 32c. Therefore, compared to when the burrs 32e are formed on upper surfaces of the respective flange portions 32c, the burrs 32e do not inhibit the insertions of the corresponding first protruding portions 21c and the first protruding portions 21c are easily inserted into the corresponding first hole portions 35 from thereabove.

As shown in FIG. 2, in a state in which the first protruding portions 21c have been inserted, a part of each flange portion 32c is located in its corresponding second recessed portion 21d. In the embodiment, the impeller cup 21 includes the plurality of first protruding portions 21c. As shown in FIG. 6, each of the plurality of first protruding portions 21c protrudes downward from the downwardly facing surface of the inner surface of a corresponding one of the plurality of second recessed portions 21d.

As shown in FIG. 2, each of the plurality of first protruding portions 21c is inserted into a corresponding one of the plurality of first hole portions 35. This makes it possible to further suppress deformation of the impeller cup 21. The number of first protruding portions 21c is the same as the number of blade portions 22. In FIG. 2, for example, the number of first protruding portions 21c is 5. The plurality of first protruding portions 21c are disposed at equal intervals around a circumference in the peripheral direction.

For example, portions of the second cylindrical portion 21a that are connected to the blade portions 22, in particular, tend to be deformed than other portions of the second cylindrical portion 21a due to the self-weight of each blade portion 22. On the other hand, in the embodiment, in the peripheral direction, at least a part of each first hole portion 35 and at least a part of its corresponding first protruding portion 21c overlap the position of the portion of the second cylindrical portion 21a that is connected to its corresponding blade portion 22. Therefore, it is possible to suitably suppress deformation of the portions of the second cylindrical portion 21a that, in particular, tend to be deformed and to further suppress deformation of the impeller cup 21. In the embodiment, in the peripheral direction, the first hole portions 35 and the first protruding portions 21c in their entirety overlap the positions of the corresponding portions of the second cylindrical portion 21a that are connected to the corresponding blade portions 22.

As shown in FIG. 4, in the embodiment, the impeller cup 21 is fixed to the rotor cup 32 with an adhesive 70. The adhesive 70 is placed at a location between each portion of the radial-direction inner surface of the second cylindrical portion 21a where the corresponding first ribs 23a are adjacent to each other in the peripheral direction and the radial-direction outer surface of the first cylindrical portion 32b, is placed at a location between each portion of the radial-direction inner surface of the second cylindrical portion 21a where the corresponding second ribs 23b are adjacent to each other in the peripheral direction and the radial-direction outer surface of the first cylindrical portion 32b, and is placed inside the first recessed portion 21e. That is, the adhesive 70 that adheres the inner surface of the second cylindrical portion 21a in the radial direction and the outer surface of the first cylindrical portion 32b in the radial direction to each other is placed inside the first recessed portion 21e. Therefore, the adhesive 70 that is placed inside the first recessed portion 21e functions as a stopper and is capable of inhibiting the impeller cup 21 from moving and coming off the rotor cup 32 in the axial direction Z.

As shown in FIG. 1, the circuit board 80 has a plate shape that extends in the radial direction. The circuit board 80 is fixed to the stator 34 on the lower side of the stator 34. The circuit board 80 is electrically connected to the motor 30.

The housing 50 is disposed outward of the motor supporting section 40 in the radial direction. The housing 50 has a cylindrical shape that extends in the axial direction Z. On an outer side of the impeller 20 and the motor 30 in the radial direction, the housing 50 surrounds the impeller 20 and the motor 30. A lower end portion of the housing 50 is connected to the motor supporting section 40 by a plurality of connection ribs 51.

The present disclosure is not limited to the above-described embodiment, such that other structures may be used. In the description below, structures that correspond to those of the above-described embodiment are, for example, given the same reference numerals as appropriate and are sometimes not described.

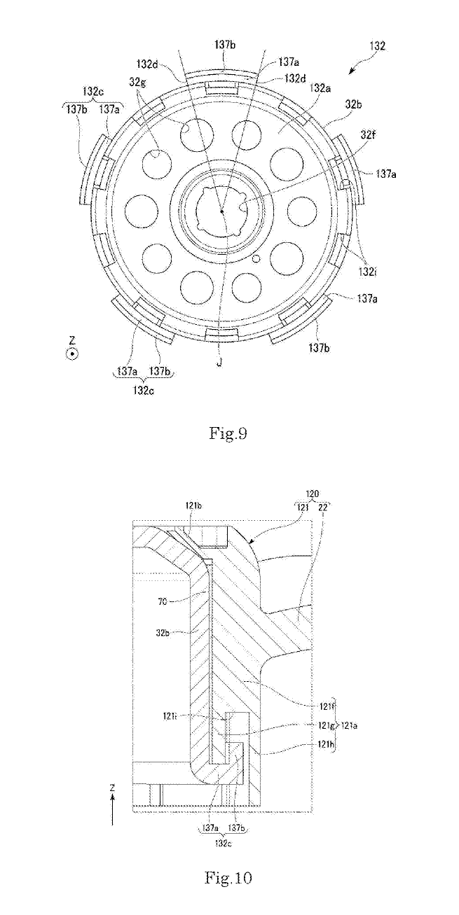

As shown in FIGS. 7 and 8, in a blower 110 of the embodiment, a cover portion 132a of a rotor cup 132 includes second hole portions 132i that are recessed downward from an upper surface of the cover portion 132a. The second hole portions 132i are located on an outer edge portion of the cover portion 132a in the radial direction. The second hole portions 132i extend through the cover portion 132a in the axial direction Z. The second hole portions 132i extend from the outer edge portion of the cover portion 132a in the radial direction to an upper end portion of a first cylindrical portion 32b. In the embodiment, the rotor cup 132 includes, for example, the plurality of second hole portions 132i. The plurality of second hole portions 132i are disposed at equal intervals around a circumference in the peripheral direction. The number of second hole portions 132i is, for example, 10.

As shown in FIGS. 8 and 9, each flange portion 132c includes a flange-portion main body 137a and a first protruding portion 137b. As shown in FIG. 8, each flange-portion main body 137a protrudes outward in the radial direction from a lower portion of the first cylindrical portion 32b. More specifically, each flange-portion main body 137a protrudes outward in the radial direction from a lower end portion of the first cylindrical portion 32b. As shown in FIG. 9, the dimension of each flange-portion main body 137a in the peripheral direction increases from its inner side in the radial direction towards its outer side in the radial direction. Two edge portions 132d on respective peripheral-direction sides of each flange-portion main body 137a extend linearly in the radial direction.

As shown in FIG. 8, each first protruding portion 137b protrudes upward from an outer end portion of its corresponding flange-portion main body 137a in the radial direction. Each first protruding portion 137b extends in the peripheral direction. Each first protruding portion 137b has the shape of a rectangular plate that is curved in the shape of an arc in the peripheral direction. The dimension of each first protruding portion 137b in the peripheral direction is the same as the dimension in the peripheral direction at the outer end portion of its corresponding flange-portion main body 137a in the radial direction.

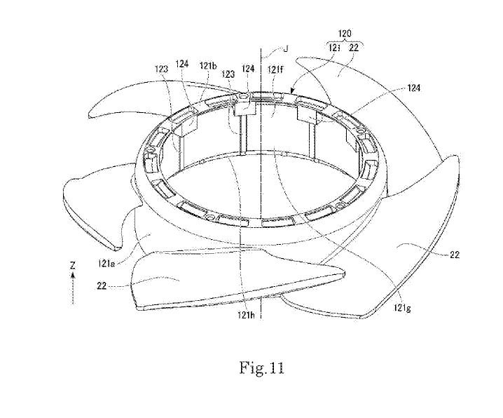

As shown in FIG. 10, in an impeller 120 of the embodiment, a second cylindrical portion 121a of an impeller cup 121 includes a main body portion 121f, an inner cylindrical portion 121g, and an outer cylindrical portion 121h. The main body portion 121f has a cylindrical shape that extends in the axial direction Z having the central axis J as the center. The inner cylindrical portion 121g has a cylindrical shape that extends downward from an inner edge portion of the main body portion 121f in the radial direction. A lower end portion of the inner cylindrical portion 121g is in contact with an upper surface of each flange-portion main body 137a.

The outer cylindrical portion 121h has a cylindrical shape that extends downward from an outer edge portion of the main body portion 121f in the radial direction. The outer cylindrical portion 121h is disposed apart from and outward of the inner cylindrical portion 121g in the radial direction. A lower end portion of the outer cylindrical portion 121h is located below the lower end portion of the inner cylindrical portion 121g. The lower end portion of the outer cylindrical portion 121h is located below each flange portion 132c.

Each first hole portion 121i that is recessed upwards from a lower end portion of the second cylindrical portion 121a is formed by the main body portion 121f, the inner cylindrical portion 121g, and the outer cylindrical portion 121h. That is, the impeller cup 121 includes the first hole portions 121i. Each first hole portion 121i is a hole having a bottom portion. At least a part of each first protruding portion 137b is located inside its corresponding first hole portion 121i. Similarly to the first embodiment, this makes it possible to suppress deformation of the impeller cup 121.

In this way, in the embodiment, the impeller cup 121 includes the first hole portions 121i and each flange portion 132c includes its corresponding first protruding portion 137b. Therefore, for example, compared to when a first hole portion is formed in each flange portion, the dimension of each flange portion 132c in the radial direction is easily reduced. This makes it easy to reduce the dimension of the blower 110 in the radial direction. In FIG. 10, each first protruding portion 137b is located in its entirety inside its corresponding first hole portion 121i. Each first protruding portion 137b is located between the inner cylindrical portion 121g and the outer cylindrical portion 121h in the radial direction. In FIG. 10, each first protruding portion 137b is located apart from the inner cylindrical portion 121g and the outer cylindrical portion 121h in the radial direction.

In the embodiment, since each first protruding portion 137b is formed so as to protrude upward from an outer end portion of its corresponding flange portion 132c in the radial direction, the outer end portion of each flange portion 132c in the radial direction can be disposed at a location that overlaps the position of its corresponding first hole portion 121i as viewed from thereabove. In the radial direction, this allows the outer end portion of each flange portion 132c in the radial direction to be disposed inward of a radial-direction outer surface of the second cylindrical portion 121a. Therefore, it is possible to suppress a reduction in the air quantity of the blower 110 and to reduce noise that is produced from the blower 110. An upper end portion of each first protruding portion 137b inserted in its corresponding first hole portion 121i is disposed on the lower side of and apart from the bottom portion of its corresponding first hole portion 121i.

As shown in FIG. 11, the impeller cup 121 includes second protruding portions 124. Each second protruding portion 124 has the shape of a quadrangular prism that protrudes downward from a contact portion 121b. As shown in FIG. 7, at least a part of each second protruding portion 124 is located inside its corresponding second hole portion 132i. Therefore, even if the impeller cup 121 tries to deform outward in the radial direction, each second protruding portion 124 is caught by an inner surface of its corresponding second hole portion 132i, such that deformation of the impeller cup 121 is further suppressed. In addition, it is possible to further suppress rotation of the impeller cup 121 with respect to the rotor cup 132 in the peripheral direction. In the embodiment, unlike the first embodiment, the contact portion 121b does not include third ribs.

In the embodiment, the impeller cup 121 includes the plurality of second protruding portions 124. The plurality of second protruding portions 124 are disposed at equal intervals around a circumference in the peripheral direction. The plurality of second protruding portions 124 are each inserted in a corresponding one of the plurality of second hole portions 132i. This makes it possible to further suppress deformation of the impeller cup 121.

As shown in FIG. 11, the impeller cup 121 includes a plurality of ribs 123 that each protrudes inward in the radial direction from an inner surface of the second cylindrical portion 121a in the radial direction. The plurality of ribs 123 are disposed at equal intervals around a circumference in the peripheral direction. In the peripheral direction, the plurality of ribs 123 are located at positions that correspond to the positions of the plurality of second protruding portions 124 corresponding thereto. The plurality of ribs 123 extend in the axial direction Z from a lower end portion of a radial-direction inner surface of the inner cylindrical portion 121g to an upper end portion of a radial-direction inner surface of the main body portion 121f. The plurality of ribs 123 are in contact with an outer peripheral surface of the first cylindrical portion 32b. This makes it is possible to reduce a stress that is produced between the impeller cup 121 and the rotor cup 132 by thermal expansion or thermal contraction and to suppress damage to the impeller cup 121 and the rotor cup 32.

In each of the above-described embodiments, the outer end portion of each flange portion in the radial direction may be located in correspondence with the position of the outer surface of the second cylindrical portion in the radial direction. Even in this case, since the outer end portion of each flange portion in the radial direction does not protrude outward of the second cylindrical portion in the radial direction, it is possible to suppress a reduction in the air quantity of the blower and to reduce noise that is produced from the blower. The outer end portion of each flange portion in the radial direction may be located outward of the radial-direction outer surface of the second cylindrical portion in the radial direction. Each flange portion may protrude outward in the radial direction from a portion on the upper side of the lower end portion of the first cylindrical portion as long as this is at the lower portion of the first cylindrical portion.

In the first embodiment, each first hole portion may be a hole having a bottom portion. In the second embodiment, each first hole portion may be a hole that extends through the second cylindrical portion in the axial direction Z. Although, in each of the embodiments, the structure in which either one of the flange portions and the impeller cup includes the first hole portions and the other of the flange portions and the impeller cup includes the first protruding portions is used, the present disclosure is not limited thereto. For example, the flange portions and the impeller cup may both include the first hole portions and the first protruding portions. In addition, the shape of each first protruding portion and the shape of each first hole portion are not particularly limited to certain shapes. The rotor cup need not have burrs.

Note that the use of the blower of each embodiment described above is not limited to certain uses.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-14. (canceled)

15. A blower comprising:
a motor that includes a shaft that is disposed along a central axis extending in an up-down direction; and
an impeller that is rotated around the central axis by the motor; wherein
the motor includes:
a stator that surrounds the shaft on an outer side of the shaft in a radial direction;
a rotor magnet that faces the stator in the radial direction with a gap interposed therebetween on an outer side of the stator in the radial direction; and
a rotor cup that includes a first cylindrical portion that has a cylindrical shape and that holds the rotor magnet;
the impeller includes:
an impeller cup that includes a cylindrical second cylindrical portion that surrounds the first cylindrical portion on an outer side of the rotor cup in the radial direction; and
a plurality of blade portions that are located on a radial-direction outer surface of the second cylindrical portion;
the rotor cup includes a flange portion that protrudes outward in the radial direction from a lower portion of the first cylindrical portion;
one of the flange portion and the impeller cup includes a first hole portion that is recessed in an axial direction;
the other of the flange portion and the impeller cup includes a first protruding portion;
at least a portion of the first protruding portion is located inside the first hole portion.

16. The blower according to claim 15, wherein, in a peripheral direction, a position of at least a portion of the first hole portion and a position of at least a portion of the first protruding portion overlap positions of portions of the second cylindrical portion that are connected to the blade portions.

17. The blower according to claim 15, wherein
the impeller cup includes a contact portion that protrudes towards an inner side in the radial direction from an upper portion of the second cylindrical portion;
the contact portion is in contact with the rotor cup on an upper side of the rotor cup; and
the flange portion is spaced apart from a lower side of the second cylindrical portion with a gap interposed therebetween.

18. The blower according to claim 15, wherein, in the radial direction, an outer end portion of the flange portion in the radial direction is located at a position substantially corresponding to a position of the radial-direction outer surface of the second cylindrical portion or is located inward of the radial-direction outer surface of the second cylindrical portion.

19. The blower according to claim 15, wherein
the impeller cup includes a plurality of ribs that protrude inward in the radial direction from an inner surface of the second cylindrical portion in the radial direction; and
the plurality of ribs are spaced apart from each other in a peripheral direction with a gap interposed therebetween and are in contact with an outer surface of the first cylindrical portion in the radial direction.

20. The blower according to claim 15, wherein
the second cylindrical portion includes a first recessed portion that is recessed outward in the radial direction from an inner surface of the second cylindrical portion in the radial direction; and
an adhesive that adheres the inner surface of the second cylindrical portion in the radial direction and an outer surface of the first cylindrical portion in the radial direction to each other is inside the first recessed portion.

21. The blower according to claim 15, wherein two edge portions on respective peripheral-direction sides of the flange portion are each inclined in a direction so as to approach the edge portion an opposite side from an inner side in the radial direction towards an outer side in the radial direction.

22. The blower according to claim 15, wherein
the rotor cup includes a cover portion that is located on an upper end portion of the first cylindrical portion;
the cover portion includes a second hole portion that is recessed downward from an upper surface of the cover portion; and
the impeller cup includes a second protruding portion, at least a portion of the second protruding portion being located inside the second hole portion.

23. The blower according to claim 15, wherein
the flange portion includes the first hole portion; and
the impeller cup includes the first protruding portion.

24. The blower according to claim 23, wherein the first hole portion is located in a center of the flange portion in the radial direction.

25. The blower according to claim 23, wherein
the first hole portion extends through the flange portion in the axial direction;
the first protruding portion protrudes downward from the second cylindrical portion; and
a lower end portion of the first protruding portion is located below the flange portion.

26. The blower according to claim 23, wherein
the first hole portion extends through the flange portion in the axial direction; and
the rotor cup includes a burr that is located on a peripheral edge portion of the first hole portion at a lower surface of the flange portion.

27. The blower according to claim 15, wherein
the impeller cup includes the first hole portion; and
the flange portion includes:
a flange-portion main body that protrudes outward in the radial direction from the lower portion of the first cylindrical portion; and
the first protruding portion that protrudes from the flange-portion main body.

28. The blower according to claim 27, wherein
the first hole portion is recessed upward from a lower end portion of the second cylindrical portion; and
the first protruding portion protrudes upward from an outer end portion of the flange-portion main body in the radial direction.
